(19) United States
(12) Patent Application Publication
(10) Pub. No.: US 2006/0291554 A1
(43) Pub. Date: Dec. 28, 2006

(54) Image processing apparatus

(75) Inventors: Petrus Wilhelmina Gertrudus Welles, Eindhoven (NL); Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, 5621 BA Eindhoven (NL)

(21) Appl. No.: 10/554,528

(22) PCT Filed: Apr. 28, 2004
(86) PCT No.: PCT/IB04/50531

§ 371 Date: Oct. 26, 2005

(30) Foreign Application Priority Data
Apr. 29, 2003 (EP) 03101176.0

(51) Int. Cl. H04B 1/66

(52) U.S. Cl. 375/240

(57) ABSTRACT

An image processing apparatus receives a base video stream and an enhancement video stream that contains information for optionally improving a quality of an output stream derived from the base video stream. An adder (126) forms an output stream by adding image information values derived for a location in an image from the base video stream and the enhancement video stream. A multiplier (124) coupled between the input and the adder adjusts a relative weight with which the information value in the base video stream and the enhancement video stream are added to each other. A weight selection unit (123) selects the relative weight as a function of position in the image and/or time in the video information, adaptive to local content of the video information.

The invention relates to an image processing apparatus that is arranged to construct a video stream from a compressed base stream and an enhancement stream.

From PCT Patent application no IB02/04297 (unpublished at the priority date of the present application) it is known to transmit image information in the form of a compressed base stream and an enhancement stream that provides for corrections of differences between an image that can be decoded from the base stream and an image from an original video stream. The base stream has a lower spatial and/or temporal resolution than the original video stream and the enhancement stream provides the information to obtain the original resolution.

The difference between the compressed stream and the original stream are multiplied, prior to encoding of the enhancement stream, with an image location dependent factor in order to reduce the bit-rate needed for the enhancement stream. This factor varies dependent on the location in the image and is selected so as to attenuate the image information in the enhancement stream in regions where there is little spatial detail. To decode video information from the base stream and the enhancement stream information from the base stream and the enhancement stream is summed for each location in an image.

According to PCT Patent application no IB02/04297 also uses the enhancement stream for sharpness control. A sharpened or flattened effect is achieved by strengthening or weakening image intensity of the enhancement information relative to the base stream. For this purpose, the image information from the enhancement stream is multiplied by a further factor, which is selected by the user to control sharpness. No detail is given about how the user should select this factor. Apparently, the factor is set manually.

Among others it is an object of the invention to provide for a further improvement of perceived image quality of a video stream that is obtained from a base video stream and an enhancement video stream.

The invention provides for a video processing apparatus according to Claim 1. The relative weight with which image information from a received base stream and the enhancement stream are combined is varied as a function of image content so that visible artifacts are reduced. The weight may be varied for example by varying a factor with which information from the enhancement stream is multiplied before being added to information from the base stream. (Applying a relative weight as used herein does not require that information from both streams is multiplied by respective factors that sum to one).

The base video stream and the enhancement stream may be received via any known transport channels, for example via a broadcast channel a cable system, the Internet or from a stream storage medium such as a magnetic or optical disk The invention is especially useful when the enhancement video stream provides for increasing the spatial or temporal resolution of the base video stream, but the invention may also be applied when the base video stream is compressed in other ways, e.g. by encoding in terms of interpolated images or quantization of information, when the enhancement information supplies information lost by interpolation or quantization.

In an embodiment the apparatus supports a range of weight values that provides alternatively for both attenuation and overemphasis of the high-resolution information from the enhancement stream. This may be used for example to create a perception of extra sharp images under image circumstances that prevent perception of disturbing artifacts, such as rapid spatial or temporal changes of image content.

In an embodiment the apparatus varies the relative weight applied to the enhancement stream according to the amount of spatial and/or temporal change in the video stream. In regions of high change a larger weight is used than in regions of low change. It is known that the human eye is especially sensitive to artifacts in regions of low change and therefore enhancement information that may give rise to artifacts is attenuated more in such regions. The amount of spatial change may be detected for example using an edge detection filter. Information about motion vectors that is used for interpolation of images may be used to detect the amount of temporal change (absence of motion vectors optionally indicating zero motion). The amount of spatial and/or temporal change may also be used to control location dependent attenuation before compressing the enhancement stream.

In a further embodiment the apparatus varies the relative weight also dependent on the local luminance, so that relatively less weight is given to the enhancement stream in regions of high luminance. Here the human eye is most sensitive to artefacts.

These and other objects and other advantageous aspects will become apparent from the following figures and their description.

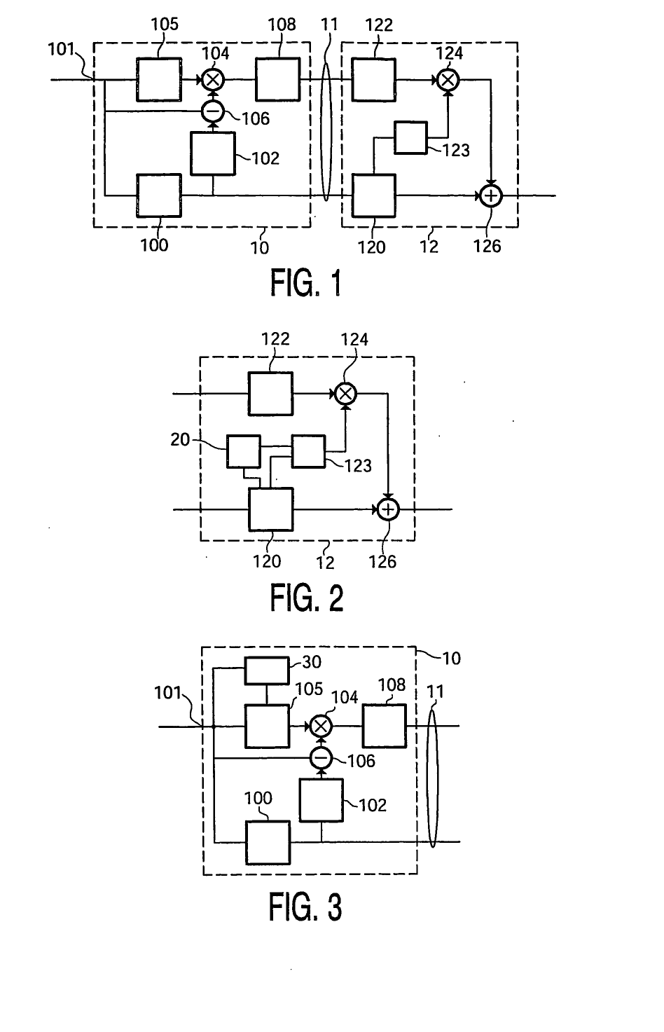

FIG. 1 shows a video processing system

FIG. 2 shows a decoder

FIG. 3 shows an encoder

FIG. 1 shows a video processing system. The system contains a compound encoder 10 and a compound decoder 12 coupled via a medium 11. By way of example medium 11 is shown as a pair of communication connections. Compound encoder 10 has an input 101 for receiving a video stream, for example from a camera or a recording device and compound decoder has an output coupled for example to a display screen (not shown) for driving the content of the display screen under control of decoded video information.

Compound encoder 10 comprises a first encoder 100, a decoder 102, a factor selection unit 105, a multiplier 104, a subtractor 106 and a second encoder 108. An image input 101 of compound encoder 10 is coupled to a first input of subtractor 106 and to first encoder 100, which has an output coupled to medium 11 and a second input of subtractor 106. Subtractor 106 has an output coupled to a first input of multiplier 104. Factor selection unit 105 has an input coupled to image input 101 and an output coupled to a second input of multiplier 104. Multiplier 104 has an output coupled to a second encoder 108, which has an output coupled to medium.

In operation first encoder 10 applies lossy encoding to image information from input 101, in a particular example, first encoder forms a low spatial and/or temporal resolution version of the received images and encodes this low resolution version, but in other embodiments other forms of lossy encoding may be used. Resulting first encoded image is transmitted to medium 11, for use by a decoder. Due to lossy encoding the decoded information corresponds only approximately with the original image information.

The remainder of compound encoder 10 is involved in the generation of enhancement information that encodes the errors due to the first encoder. The enhancement stream is provided for optional used by a decoder to improve the image information decoded from the first encoded image information so that the result more closely approximates the original image information. In the example where first encoder 100 encodes a low-resolution version of the image, the enhancement stream contains the information needed for obtaining a sharper high-resolution image.

By way of example, the generation of the enhancement information is illustrated schematically with a decoder 102, which reconstructs image information from the encoded image, so that, but for compression losses, the original image information would be reconstructed at the original resolution. Subtractor 106 determines the error due to encoding, for example on a pixel-by-pixel and frame by frame basis. Factor selection unit 105 selects a factor for each pixel and frame adaptive to the image content. A low factor is selected for example in regions of an image where there is low contrast Multiplier 104 multiplies the pixels with the selected factors and applies the results to second encoder, which encodes the information and applies it to medium 11.

FIG. 3 shows an alternative embodiment of the encoder, which contains a change detector 30 that detects changes in the content of corresponding regions in successive images. Change detector 20 may for example compute the cumulative difference between pixels in each of a number of regions around respective pixel locations. In this embodiment factor selection unit 105 selects the factor dependent on the amount of change, for example by reducing the factor locally in images around a location where the image changes around that location from one image to another.

Although medium 11 is shown as a pair of connections, it should be understood that any medium could be used, such as a single connection over which both first encoded information and enhancement information are transmitted, or a storage medium or media in which both are stored or mixtures thereof.

Compound decoder 12 comprises a first decoder 120, a second decoder 122, a factor selector 123, a multiplier 124, and an adder 126. First decoder 120 is coupled to medium 11 for receiving the first encoded information and has a first output coupled to a first input of adder 126. A second output is coupled to factor selector 123, which has an output coupled to a first input of multiplier 124. Second decoder 122 is coupled to medium 11 to receive the enhancement information and has an output coupled to a second input of multiplier 124. Multiplier 124 has an output coupled to a second input of adder 126.

In operation first decoder 120 decodes the first encoded information and supplies it to adder 126. Second decoder 122 decodes the enhancement information and supplies decoded information to multiplier 124, for example on a pixel-by-pixel and frame-by-frame basis. Multiplier 124 multiplies the decode information by a factor g supplied by factor selector 123 and supplies the product to adder 126, where it is added to the information decoded from first encoded information.

Various ways of selecting the factor g may be implemented in factor selector 123. In a first embodiment, factor selector 123 adapts the factor g according to the amount of “motion” detected in the decoded images. When the first encoded information is MPEG encoded information, for example, the information contains motion vectors D that describe the displacement of information in a block of pixels in one image to pixels at a different location in another image. In this embodiment factor selector 123 adapts the factor gᵢ for a pixel i to the length of a motion vector Di associated with an image according to
gᵢ=F(Di)

Where the function F(Di) may be defined for example using a look-up table, or using an arithmetic circuit that computes F(Di) as a function of Di. An example of a useful function is F(x)=Di*Di/(1+Di*Di). Preferably the function F(D) decreases towards zero with decreasing Di. Thus artefacts resulting from the enhancement information are suppressed in areas where there is little motion so that the human eye is sensitive to artifacts. As associated Di for a pixel one may take for example the motion vector for the block to which the pixel belongs used to encode the frame, which is being decoded, or a temporally adjacent frame. Alternatively one might use the motion vector of a block that is to displaced over or to a region to which the pixel belongs, according to the motion vector for that block, but this may require more overhead.

The use of motion vectors from the first encoded information has the advantage that no separate determination of motion is necessary within compound decoder 12. However, it will be appreciated that the amount of motion can also be determined in other ways, for example by determining an amount of change in a region around the pixel i from one frame to the next.

In another embodiment, the factor selector 123 selects factor gᵢ for a pixel location i according to the amount of detail A in an area of the image surrounding or near the pixel location.

FIG. 2 shows a decoder that contains an edged detector 20 coupled between first decoder 120 and factor selector 123 for this purpose. A measure of the amount of detail A can be obtained for example by a Laplacian type of operator, by multiplying pixel values in a matrix of locations at and around the pixel by factors

| | | |
|---|---|---|
| −1 | −1 | −1 |
| −1 | 8 | −1 |
| −1 | −1 | −1 |

(the pixel value for pixel i being multiplied by 8) and summing the products. Of course other types of operator that are sensitive to spatial variations in image content may be used. Preferably, the amount of detail A could be determined from the image decoded by first decoder 120, which works well, but an image obtained by combining the image decoded by first decoder and enhancement information may also be used. Factor selector 123 selects the factor gᵢ according to gᵢ=H(A), where H is a function which may be implemented for example using a lookup table or an arithmetic circuit. H decreases when the amount of detail decreases, for example according to H(x)=x*x/(1+x*x). As a result enhancement is suppressed in regions of the image where there is little detail, where the human eye is sensitive to artifacts.

In a further embodiment factor selector 123 may adapt the factor gᵢ according to the average luminance L in a region surrounding a pixel location i. It is known that the sensitivity of the human eye has a maximum at a certain luminance level. By making the factor gᵢ=K(L) minimal when the average luminance L equals this level and higher when the average luminance differs from this level, observed artifacts are reduced. Specifically for pixel locations i in relatively dark areas the factor gᵢ may be increased relative to lighter area's.

In a further embodiment of factor selector 123 these methods of varying the factor gᵢ may be combined, for example by taking the product of the various factors G, H, K or using different functions G and or H for different luminance levels L.

The invention is particularly useful in the case where the first encoded image is a low resolution image and the enhancement information provides for restoring the image to higher resolution. In this case the adaptive factors effectively implement a form of adaptive spatial filtering of the image.

In a first embodiment factor selector 123 selects the factor from a range between 0 and 1, so that the enhancement information is added at most fully to the information decoded by first decoder and at least no information is added. In this case, in areas of the image where the eye is little sensitive to artifacts, a high-resolution image with effectively no filtering is restored and where the eye is more sensitive to artifacts the image is low pass filtered. However, in a second embodiment the factor may locally be selected higher than 1. In this case the sharpness of the image is exaggerated in areas of the image where the eye is little sensitive to artifacts, to realize a sharpened image perception without creating disturbing artifacts.

It will be appreciated that the various encoders, decoders, adder/subtractors and multipliers may be realized as dedicated circuits in one or more integrated circuits, but that instead these functions may be performed at least partly using a suitably programmed processor circuit The same holds for factor selector 123, which may be implemented by a programmed processor that computes the factors g as a function of decoded image information and/or encoded information such as motion vectors, but which may also be implemented by means of dedicated circuits, such as image filters to compute an amount of motion and/or detail and or one or more look-up memories to compute the factors g.

It will also be appreciated that the invention is especially useful when the enhancement information provided for additional spatial resolution. Thus, increasing and decreasing the weight of the enhancement information corresponds to highpass and lowpass filtering respectively. However, the invention applies as well to conditions where the base video stream is enhanced in other ways. For example, if the temporal resolution is enhanced by providing enhancement information to produce images or frames at higher rate, temporal and spatial variation of the weight of the enhancement information may be used to reduce flicker or to provide smoother motion effects when the detected spatial variation indicates that this will not lead to strong perceptible artifacts.

1. An image processing apparatus, comprising
an input for coupling to a transport channel (11) for receiving video information comprising a base video stream and an enhancement video stream that contains information for optionally improving a quality of an output stream derived from the base video stream;
an adder (126) arranged to form the output stream by adding image information values derived for a location in an image from the base video stream and the enhancement video stream;
a multiplier (124) functionally coupled between the input and the adder (126) so as to adjust a relative weight with which the information value in the base video stream and the enhancement video stream are added to each other;
a weight selection unit (123) arranged to select the relative weight as a function of position in the image and/or time in the video information, adaptive to local content of the video information.

2. An image processing apparatus according to claim 1, wherein the enhancement video stream provides information used for increasing a spatial and/or temporal resolution provided by the base video stream.

3. An image processing apparatus according to claim 2, wherein the weight selection unit (123) is arranged to select the weight from a range that contains different weights with which the information value from the enhancement stream can be attenuated and overemphasized relative to the base video stream respectively.

4. An image processing apparatus according to claim 1, wherein the weight selection unit (123) is arranged to select the relative weight at a position in the video information responsive to a detected amount of temporal and/or spatial change of the video information in a region that includes the position, so that the weight of the information value from the enhancement stream relative to the information value derived from the base video stream is increased when said amount is relatively high and decreased when said amount is relatively low.

5. An image processing apparatus according to claim 4, wherein the weight selection unit (123) is additionally responsive to a luminance in said region, so that the weight of the information value from the enhancement stream relative to the information value of the base stream is increased when said the luminance is relatively high and decreased when the luminance is relatively low.

6. An image processing apparatus according to claim 4, comprising a spatial change sensor (20) responsive to spatial change in the region, the spatial change sensor (20) being coupled to the weight selection unit (123) to control the relative weight responsive to spatial changes.

7. An image processing apparatus according to claim 4, wherein the base video stream is encoded using motion vectors, the weight selection unit (123) being arranged to select the weight dependent on a size of a motion vector value associated with the region according to the encoding.

8. An image processing apparatus, comprising
a video encoder (10) arranged to encode video information into a base video stream and an enhancement video stream from video information for supplying a part of the video information that is lost in the base video stream;
a temporal change detector (30) coupled to detect an amount of temporal change between successive images in the video information in a common region in the images, the region containing a location;
a factor selection unit (105) for selecting a time and location dependent factor for said location responsive to the amount of temporal change, so that the factor increases with increasing change;
a multiplier (104) functionally coupled to apply the location and time dependent factor to the image information in the enhancement video stream prior to encoding.

9. A method of processing a video stream, the method comprising
receiving a base video stream and an enhancement video stream that contains information for optionally improving a quality of an output stream derived from the base video stream;
selecting a relative weight as a function of position in an image in the video stream and/or time in the video stream, adaptive to image information in the video stream.
adding image information values derived for a location in an image from the base video stream and the enhancement video stream;
adjusting a relative weight with which the information value in the base video stream and the enhancement video stream are added to each other, adaptive to a content of the video stream around said location as a function of location and/or time.
